(19) United States
(12) Patent Application Publication
(10) Pub. No.: US 2014/0151584 A1
(43) Pub. Date: Jun. 5, 2014

(54) NUCLEAR RADIATION SHIELDS, SHIELDING SYSTEMS AND ASSOCIATED METHODS

(71) Applicant: BloXR Corporation, (US)

(72) Inventors: Ashok C. Khandkar, Salt Lake City, UT (US); Prataprai Chowdhary, Salt Lake City, UT (US)

(73) Assignee: BLOXR CORPORATION, Salt Lake City, UT (US)

(21) Appl. No.: 13/663,467

(22) Filed: Oct. 29, 2012

(51) Int. Cl. G21F 1/00

(52) U.S. Cl. CPC G21F 1/00
USPC 250/519.1; 250/515.1

(57) ABSTRACT

A radiation shield, which may attenuate nuclear radiation or ionizing particles, may include a non-toxic, radioactivity-attenuating material based on an element or an elemental species having an atomic number of 56 or more. Examples of such materials include barium sulfate and bismuth oxide. A radiation shield may include two or more different radioactivity-attenuating materials, which may attenuate different types of nuclear radiation or ionizing particles, or attenuate different energy ranges of nuclear radiation or ionizing particles. Different radioactivity-attenuating materials may be carried by different layers of the radiation shield. Radiation shields with at least partially superimposed layers are also disclosed. Adjacent layers of such a radiation shield may be able to move longitudinally relative to one another, or slide somewhat relative to each other. Any of these features may be incorporated into a blanket, a protective suit or other protective garment, tape or any other configuration of radiation shield. Pliable radiation shields that attenuate nuclear radiation or ionizing particles are also disclosed, as are methods for limiting exposure to nuclear radiation or ionizing particles.

### TECHNICAL FIELD

This disclosure relates generally to radiation shields, such as blankets, fitted or customized shields, enclosures, panels, flooring pads or mats, drapes or protective suits or other wearable garments, pipe wraps or covers, tape, pliable materials (e.g., putties, etc.), pourable or flowable materials, gels, or the like, which are configured to limit exposure of humans, and other sensitive objects such as electronic circuits to or reduce dosages of nuclear radiation, or radioactivity, which may be in the form of ionizing radiation (e.g., alpha particles, beta particles, gamma rays (or photons), etc.). More specifically, this disclosure relates to radiation shields formed from non-toxic, relatively lightweight materials that attenuate nuclear radiation. In addition, flexible radiation shields are disclosed. This disclosure also relates to methods for reducing or minimizing a dosage of nuclear radiation, or radioactivity or ionizing particles, to which a subject may be exposed.

### RELATED ART

Individuals who work in environments where radioactive materials are present, such as nuclear power facilities or nuclear recycling or waste facilities, are typically required to carry dosimeters. A dosimeter measures the quantity of nuclear radiation, or radioactivity, to which an individual is exposed. Knowledge of an individual's exposure to nuclear radiation is important, particularly in environments where individuals are not provided with protective suits or other protective garments and since governmental and/or private regulations often limit the dosage of nuclear radiation to which an individual may be exposed over a given period of time. Typically, the maximum annual dosage of radiation for individuals who routinely work around radioactive materials and other types of ionizing radiation is 5,000 millirems (mrem).

Radiation blankets are often used to limit an individual's exposure to nuclear radiation in environments where relatively high levels of radioactivity are present. More specifically, one or more radiation blankets may be positioned over areas where exposure to nuclear radiation is most likely. The use of radiation blankets is intended to decrease the cumulative dosage of nuclear radiation to which an individual is exposed, as measured by a dosimeter used by the individual. Thus, when radiation blankets and other radiation shields are properly used, the total amount of time each individual may work in that environment over a given period of time may be increased, which may reduce employee downtime and, thus, improve worker efficiency.

Radiation blankets are often formed from a single material such as lead (Pb) plate or lead wool. Another form of a radiation blanket made from a single attenuating material is in the form of a polymer that is impregnated with tungsten (W) particles. Lead plate is typically dense and provides an effective barrier to the ionizing particles of nuclear radiation, or radioactivity, emitted by radioactive materials. Although lead is flexible for a metal, lead plate is still relatively rigid and somewhat brittle and, thus, subject to cracking and/or breaking. Lead wool, in contrast, includes fine strands of lead (e.g., strands having diameters of 0.005 inch to 0.015 inch) of varying lengths that are woven, or interlaced, with one another and pressed together, or compacted. While lead wool is much less dense that lead plate, it is much more flexible. Nonetheless, the flexibility of compacted lead wool is still limited, and lead wool is very friable, easily subject to cracking or breakage and unraveling of the compacted lead strands. Such cracking may lead to gaps in radiation protection, resulting in leakage of harmful radiation. Tungsten or iron-based radiation blankets are more flexible and less susceptible to cracking or damage than lead wool radiation blankets. However, these radiation blankets are often relatively thick and, as a result, lack a desirable degree of flexibility. Furthermore, over time, particularly when exposed to high temperatures and nuclear radiation, the polymer of tungsten-based radiation blankets hardens, which may render it less flexible and more prone to cracking. Another problem associated with employing a single material such as tungsten for attenuating radiation is that tungsten by itself releases additional photons due to the photoelectric effect.

Regardless of the construction of a radiation blanket, cracks or breaks in its radioactivity-attenuating materials provide additional passages through which ionizing particles may pass. Furthermore, since the cracked or broken material is made from a toxic material such as lead, after use, the radiation blanket becomes a mixed waste, or waste that contaminated with both radioactivity and toxic materials. In view of the toxicity of lead, its release from a radiation blanket is considered to be highly undesirable.

As a radiation blanket that employs a single attenuating material, such as lead or tungsten, attenuates nuclear radiation, the photo-electric effect may cause that attenuating material to generate additional photons. Since these additional photons may also be harmful, the ability of radiation blankets that rely on a single material to attenuate radioactivity and, thus, to minimize the doses of radioactivity or other ionizing radiation to which personnel may be exposed may be less than ideal.

### SUMMARY

As used herein, the term “disclosure” and variations thereof refer to the subject matter disclosed herein, including novel and inventive features, regardless of whether or not those features appear in any of the appended claims.

A radiation shield may include a radioactivity-limiting element, which is configured to attenuate, or limit the passage of ionizing particles, or radioactivity, therethrough. The radiation shield may be embodied in a wide variety of form factors. Without limitation, a radiation shield may comprise a blanket, form-fitted or customized shield, enclosure, panel, drape, flooring pad or mat, protective suit or other wearable garment, pipe wrap or cover, tape, pliable material (e.g., a putty, etc.), pourable materials, gel, or it may have any of a number of other forms.

Optionally, the radioactivity-limiting element of the radiation shield may be disposed within a shell (e.g., in some embodiments of blankets, protective suits, etc.). The shell may define an exterior of the radiation shield, as well as the interior of the radiation shield, within which the radioactivity-limiting element may be disposed. The shell may have or provide any of a variety of desirable properties, including, but not limited to, durability, flexibility, crack resistance, heat resistance, water resistance or waterproofing, slip resistance, or any other desirable properties, as well as any combination of desired properties.

The radioactivity-limiting element of any embodiment of radiation shield that incorporates teachings of this disclosure may include at least one non-toxic, radioactivity-attenuating material. Such a material may be based on an element or elemental species or compound having an atomic number of 56 or greater. Non-limiting examples of such elements or elemental species include barium (Ba) species, bismuth (Bi) species and lanthanum (La) species. In some embodiments, the non-toxic, radioactivity-attenuating material may comprise an organic or inorganic salt based on an element or elemental species with an atomic number of 56 or greater. Specific examples of such inorganic salts include, but are not limited to, barium sulfate (BaSO₄) and bismuth oxide (Bi₂O₃).

A radioactivity-limiting element may include two or more radioactivity-attenuating materials. One or more of the radioactivity-attenuating materials may be a non-toxic material that comprises an element or elemental species or compound having an atomic number of 56 or greater. In some embodiments, radioactivity-attenuating materials with different properties may be arranged in a manner (e.g., sequentially, etc.) that tailors or optimizes the ability of the radioactivity-limiting element to limit the dose of radioactivity and other ionizing radiation that may pass through the radioactivity-limiting element.

In some embodiments, the radioactivity-attenuating material of the radioactivity-limiting element of a radiation shield according to this disclosure may be flexible and, optionally, resist cracking. Such a radioactivity-limiting element may include a polymer that carries particles of a radioactivity-attenuating material (e.g., a non-toxic radiation-attenuating material based on an element or elemental species with an atomic number of 56 or greater, etc.). The polymer may impart the radioactivity-limiting element with flexibility. In some embodiments, the polymer and radioactivity-attenuating material may be formed into sheets, films, interlocking panels, strands, threads, fabrics, mesh, webs, pipes or tubes or other structures. Such structures may include a single type of radioactivity-attenuating material or a plurality of radioactivity-attenuating materials. In other embodiments, the polymer may provide a pliable carrier (e.g., a putty, etc.), a semisolid material (e.g., a resin, a paint, an ink, etc.), or it may impart the radioactivity-limiting element with any other desired characteristics.

Optionally, regardless of the material(s) from which a radioactivity-limiting element of a radiation shield is (are) formed, the radioactivity-limiting element may comprise a plurality of at least partially superimposed layers, at least some of which are configured to attenuate ionizing particles. The superimposed layers may remain substantially unbound from one another; i.e., adjacent layers may not be adhered to one another or any adhesion between adjacent layers may be readily overcome with a small amount of force (e.g., the force of gravity acting on portions of a radiation shield that that have been draped over an object, a comparable or even lesser amount of force along a horizontal vector, etc.). When adjacent layers of a radioactivity-limiting element remain substantially unbound from each other, substantially unbound layers may move longitudinally, or slide (at least slightly), relative to (e.g., over, etc.) each other. This freedom of movement may impart the radioactivity-limiting element with additional flexibility (e.g., over and above that provided by the construction of each layer, the material(s) from which each layer is formed, etc.). Moreover, the relative separation (e.g., relative to layers that have been adhered to one another, etc.) of adjacent layers may prevent any cracking that might occur in one layer to spread into an adjacent layer. Alternatively, under some circumstances, lamination of the layers of a multi-layered radioactivity-limiting element may be desirable; i.e., adjacent layers may be permanently or semi-permanently adhered to or coated on one another.

Different layers of a radioactivity-limiting element may be formed from materials that have different radioactivity attenuating characteristics. In some embodiments, one layer may include a different radioactivity-attenuating material than another layer. In other embodiments, one layer may include (a) different amount(s) or thickness(es) of one or more radioactivity-attenuating materials than another layer. Of course, other variations between two or more of the layers of a radioactivity-limiting element are also within the scope of this disclosure. As an example, one or more first layers may be configured to attenuate nuclear radiation or ionizing particles of a first energy or a first range of energies, while one or more second layers may be configured to attenuate nuclear radiation or ionizing particles of a second energy or a second range of energies. More specifically, each layer that includes the first type of radioactivity-attenuating material may be configured to attenuate relatively high energy nuclear radiation or relatively high energy ionizing particles, while each layer that includes the second type of radioactivity-attenuating material may be configured to attenuate relatively low energy nuclear radiation or relatively low energy ionizing particles. As an even more specific, but non-limiting example, a first layer that includes a radioactivity-attenuating material that is based on an element or elemental species or compounds having a relatively low atomic number (when compared with the atomic number of an element or elemental species upon which another radioactivity-attenuating material of the radioactivity-limiting element 30 is based), or a “low Z material” (e.g., barium, which has an atomic number of 56; lanthanum, which has an atomic number of 57; etc.) may included in the same radioactivity-limiting element as (e.g., be positioned adjacent to, be spaced apart from, etc.) a second layer that includes a radioactivity-attenuating material that is based on an element, an elemental species or a compound with a relatively high atomic number (when compared with the atomic number of an element or elemental species upon which another radioactivity-attenuating material of the radioactivity-limiting element 30, such as the low Z material, is based), or a “high Z material” (e.g., bismuth, which has an atomic number of 83, etc.). The first layer, which includes the low Z material, may be configured to attenuate relatively high energy nuclear radiation or relatively high energy ionizing particles, while the second layer, which includes the high Z material, may be configured to attenuate relatively low energy nuclear radiation or relatively low energy ionizing particles.

A radioactivity shielding system may include two or more different types of radiation shields, at least one of which may incorporate novel and inventive teachings from this disclosure. The different types of radiation shields may have different physical properties from each other. As a non-limiting example, one or more of a radiation-limiting tape, a radiation-limiting putty or a coating may be used in conjunction with a radiation blanket. Optionally, the different types of radiation shields may be used in a similar manner, but attenuate ionizing radiation of different types or energies.

Various embodiments of methods of using radiation shields according to this disclosure are also disclosed.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIG. 1 is a perspective view of an embodiment of a radiation shield, which is depicted as comprising a radiation blanket;

FIG. 2 is a cross-sectional representation of the radiation shield shown in FIG. 1, showing a shell of the radiation shield and a radioactivity-limiting element covered by the shell;

FIG. 3 provides a close-up, cross-sectional illustration of an embodiment of the radioactivity-limiting element shown in FIG. 2, which includes a plurality of superimposed layers;

FIG. 4 illustrates an embodiment of a layer that may be included in the radioactivity-limiting element of FIGS. 2 and 3;

FIG. 5 is a schematic representation of a setting in which a radiation shield, such as that shown in FIGS. 1-3, may be used;

FIG. 6 illustrates an embodiment of a manner in which relatively low Z materials and relatively high Z materials may be used together to attenuate both incident and secondary ionizing radiation;

FIGS. 7 and 8 are graphs comparing the abilities of radiation blankets that include barium sulfate or bismuth oxide to attenuate radioactivity with the ability of lead-based blankets to attenuate radioactivity;

FIGS. 9 and 10 depict embodiments of radioactivity-attenuating tapes; and

FIG. 11 provides a representation of a pliable radiation shield.

### DETAILED DESCRIPTION

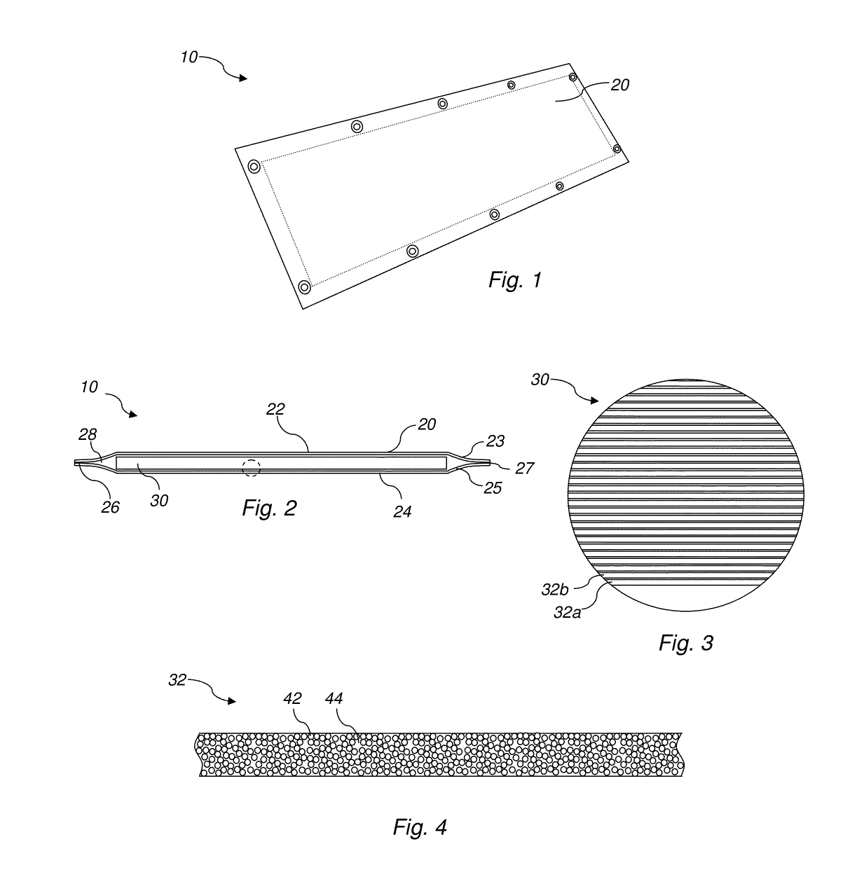

With reference to FIGS. 1 and 2, an embodiment of a radiation shield 10 is illustrated. While the radiation shield 10 is depicted as a so-called “radiation blanket,” the concepts illustrated by FIGS. 1 and 2 may be applied to a variety of other form factors, including, without limitation, form-fitted structures, customized structures, protective suits and other protective garments, enclosures, panels, drapes, mats and other protective structures. The embodiment of radiation shield 10 shown in FIGS. 1 and 2 includes a shell 20, which defines an exterior of the radiation shield 10, and a radioactivity-limiting element 30 within the shell 20.

In the depicted embodiment, the shell 20 includes two layers 22 and 24 (e.g., a top and a bottom, etc.) that are secured to one another at their peripheries 23 and 25, respectively, and at a periphery 27 of the shell 20. Optionally, the layers 22 and 24 may be secured to one another at one or more other, non-peripheral, or interior, locations. The locations at which the layers 22 and 24 of the shell are joined to one another are referred to herein as “joints 26.” One or more portions of the layers 22 and 24 may remain separate (or may be separable) from one another at locations between joints 26. As shown, the layers 22 and 24 may separate (or be separable) across the majorities of their respective areas. Thus, one or more a receptacles, or an interior 28 of the shell 20, may be defined between superimposed portions of the layers 22 and 24 of the shell 20.

The layers 22 and 24 of the shell 20 may be identical to one another (e.g., they may be identical in appearance, they may be formed from the same material(s), etc.). In some embodiments, however, the layers 22 and 24 may function differently from one another. As an example, layer 22 and 24 may have different physical characteristics from each other (e.g., layer 24 may comprise a non-slip material, a material that is more resistant to heat, moisture and/or chemicals than layer 24, etc.). As another example, layer 22 and layer 24 may be distinctive from one another in appearance, which may merely be a consequence of the materials from which the layers 22 and 24 are formed, result from the use of distinctive features on layers 22 and 24 formed from the same material, or be caused by other factors. In a specific embodiment, the appearance of layer 22 may have an appearance (e.g., a color, a pattern, a design, etc.) or bear indicia (e.g., text, symbols, etc.) that indicate that layer 22 is the top of the shell 20 and, thus, of the radiation shield 10 and/or layer 24 may have an appearance or bear indicia indicating that layer 24 is the bottom of the shell 20 and the radiation shield 10. Such a configuration may ensure that the radiation shield is oriented properly relative to a source or a potential source of nuclear radiation for any of a variety of reasons; for example, to optimize attenuation of the nuclear radiation, to ensure that the radiation shield 10 remains in place, etc.

Each layer 22 and 24 of the shell 20 may be formed from any suitable material that will provide the characteristics desired of that layer 22, 24. Examples of characteristics that may be considered in selecting the material(s) from which each layer 22, 24 is formed include, but are certainly not limited to, durability, flexibility, crack resistance, heat resistance, water resistance or waterproofing, slip resistance, tear resistance, radiation resistance, non toxicity, or any other desirable properties, as well as any combination of desired properties.

One or more radioactivity-limiting elements 30 may be disposed within the interior 28 of the shell 20. The configuration of each radioactivity-limiting element 30 may depend upon the manner in which the radiation shield 10 is intended to be used.

FIG. 3 illustrates a portion of an embodiment of radioactivity-limiting element 30 that includes a plurality of layers 32a, 32b, etc., adjacent ones of which are at least partially superimposed relative to one another. For the sake of simplicity, each layer 32a, 32b, etc., may also be referred to as a “layer 32,” and two or more layers 32a, 32b, etc., may be collectively referred to as “layers 32.” Although the term “layers” is used throughout the specification in reference to a specific embodiment of radioactivity-limiting element 30, other structures that may be positioned next to one another to attenuate radioactivity in a desired manner are also within the scope of this disclosure. Non-limiting examples of such structures include other structures that may be organized vertically relative to one another (i.e., in at least partially superimposed relation) (e.g., coatings, stratified structures, graded structures, etc.), as well as structures with elements that are arranged in a more horizontal manner (i.e., laterally adjacent to one another) (e.g., in matrices, into quasi-random structures, into random structures, etc.) and structures that include elements that are organized in combinations of vertical and horizontal relations to each other.

Adjacent layers 32 of a radioactivity-limiting element 30 may be configured and/or assembled in a manner that enables adjacent layers 32 (e.g., layers 32a and 32b, etc.) to move relative to one another (e.g., slide across each other, etc.). Thus, all or portions of adjacent layers 32 may not be adhered or attached to one another, or any adhesion or attachment between the adjacent layers 32 may be readily overcome with a small amount of force (e.g., the force of gravity acting on portions of a radiation shield that that have been draped over an object, a comparable or even lesser amount of force along a horizontal vector, the amount of force required to overcome van der Waals adhesion or electrostatic adhesion between the materials of the adjacent layers 32, etc.). In some embodiments, adjacent layers 32 may be secured to one another at intermittent, or spaced apart, locations (e.g., spots, linear locations, etc.), while the remaining regions of the adjacent layers 32 may be unattached, unadhered reversibly adhered to one another.

The layers 32 of such a radioactivity-limiting element 30 may be formed from a variety of materials, including, but not limited to, films, layers, interlocking panels, strands, mesh, threads, fabrics, mesh, webs, tubes, pipes, or other structures that include non-toxic materials that will attenuate nuclear radiation and/or ionizing radiation, as well as films, layers, foils, or other structures that include materials that have been conventionally used to attenuate nuclear radiation and/or ionizing radiation. In some embodiments, one or more layers 32 of a radioactivity-limiting element 30 may include particles of a radioactivity-attenuating material that are held together by or dispersed throughout a polymer. Optionally, one or more layers of a radioactivity-limiting element 30 may include a polymer film that carries a radioactivity-attenuating material (e.g., in the form of particles, films, foils, etc.) on its surface, or the radioactivity-attenuating material may be captured between two polymer film layers. In such embodiments, particles of the radioactivity-attenuating material may also be held together with a polymer or dispersed throughout a polymer.

In some embodiments, such as that depicted by FIG. 4, a layer 32 may include particles 42 of a radioactivity-attenuating material that are held together by or dispersed throughout a polymer 44. A number of factors, such as the type(s) of polymer(s) used, the size(s) and/or morphologies of the particles 42 of the radioactivity-attenuating material(s), the relative proportions of the radioactivity-attenuating material(s) and the polymer(s), and/or the thickness of the layer 32, may affect the flexibility, durability, and/or other characteristics of the layer 32. While FIG. 4 shows a layer 32 throughout which the particles 42 of radioactivity-attenuating material are dispersed homogeneously or substantially homogeneously, layers with non-homogeneous particle 42 distributions (e.g., gradients, random distributions, etc.) are also within the scope of this disclosure.

Without limiting the possible scope of materials, proportions, characteristics and other features of a layer 32 of a radioactivity-limiting element 30 of a radiation shield 10, the polymer 44 may comprise a flexible polymer. The polymer 44 may comprise a material that retains its flexibility when exposed to heat and/or nuclear radiation or ionizing particles, and may retain its flexibility when exposed to heat and/or nuclear radiation or ionizing particles repeatedly or for prolonged periods of time. In some embodiments, the particles 42 of radioactivity-attenuating material may be held together with the polymer 44. In embodiments where the layer 32 of the radioactivity-limiting element 30 includes a sufficient amount of the polymer 44, the particles 42 of radioactivity-attenuating material may be dispersed throughout the polymer 44.

Also without limitation, the particles 42 of radioactivity-attenuating material of the layer 32 may comprise a non-toxic material that comprises or is based upon an element or elemental species or compound having an atomic number of 56 or greater. Non-limiting examples of such elemental species include barium species, bismuth species and lanthanum species. In some embodiments, the radioactivity-attenuating material may comprise an organic or inorganic salt. Non-limiting examples of non-toxic, radioactivity-attenuating inorganic salts include barium sulfate and bismuth oxide.

The layer 32 may have a percent solids loading (by weight) that imparts it with a desired distribution, a desired particle 42 density and, thus, while also considering the thickness of the layer 32, with the ability to attenuate nuclear radiation or other ionizing radiation by a desired amount, or extent. While virtually any percent solids loading that will impart the layer 32 with desired properties may be used, in some embodiments, the percent solids loading of the layer 32 may be eighty percent (80%), by weight, to about ninety percent (90%), by weight.

In one example, the polymer 44 of a layer 32a may comprise vinyl, while the particles 42 of the layer 32b may be formed from barium sulfate, and the percent solids loading of particles 42 of the layer 32a may be about eighty percent (80%), by weight, to about eighty-two percent (82%), by weight. Such a layer 32a may have a thickness (or an average thickness) of about 0.6 mm.

In another example, a layer 32b may include vinyl as its polymer 44 and particles 42 of bismuth oxide. The percent solids loading of the particles 44 of the layer 32b may be about eighty-five percent (85%), by weight, to about eighty-seven percent (87%), by weight. The layer 32b may have a thickness (or an average thickness) of about 0.6 mm.

With returned reference to FIGS. 1-3, a specific embodiment of radiation shield 10 includes a radioactivity-limiting element 30 with a plurality of superimposed layers 32. In embodiments where a thickness or weight per unit area (e.g., pounds per square foot, etc.) of the radiation shield 10 may be limited, the number of layers 32 of the radioactivity-limiting element 30 may correspond to the desired or maximum thickness or weight per unit area of the radiation shield 10, the thickness or weight per unit area of the layers 22 and 24 that form the shell 20 of the radiation shield 10 and the thickness or weight per unit area of each layer 32 of the radioactivity-limiting element 30. For example, the radioactivity-limiting element 30 may include twenty (20) or more layers 32. In embodiments where the radiation shield 10 has a maximum weight per unit area of one (1) pound per square foot and the radioactivity-limiting element 30 includes layers 32 that comprise one or both of the embodiments disclosed in the two preceding paragraphs (i.e., a 0.6 mm thick layer including vinyl and barium sulfate and having a percent solids loading of about 80% to about 82%, by weight; a 0.6 mm thick layer including vinyl and bismuth oxide and having a percent solids loading of about 85% to about 87%, by weight; or any combination of these layers), the radioactivity-limiting element 30 may include any number of layers 32 from twenty (20) to thirty (30), or from twenty-four (24) to twenty-eight (28).

In some embodiments, the radioactivity-limiting element 30 may include layers 32 that have different properties from one another. The layers 32 of such an embodiment may be arranged in any order. In some implementations, the order and/or positioning of (e.g., spacing between, etc.) layers 32 that have different physical characteristics from one another may be designed or configured to impart the radioactivity-limiting element 30 with one or more desired characteristics.

As an example, layers 32 with different properties may be arranged in a way that increases the range or ranges of energies of nuclear radiation or ionizing particles that may be attenuated by the radioactivity-limiting element 30. Each layer 32 that includes a first type of radioactivity-attenuating material may be configured to attenuate nuclear radiation or ionizing particles of a first energy or a first range of energies, while each layer 32 that includes a second type of radioactivity-attenuating material may be configured to attenuate nuclear radiation or ionizing particles of a second energy or a second range of energies. More specifically, each layer that includes the first type of radioactivity-attenuating material may be configured to attenuate relatively high energy nuclear radiation or relatively high energy ionizing particles, while each layer that includes the second type of radioactivity-attenuating material may be configured to attenuate relatively low energy nuclear radiation or relatively low energy ionizing particles. Depending on the source or radioactivity, the energy spectrum and/or other factors, other arrangements may be utilized, including, without limitation, a reverse configuration to that disclosed by this paragraph.

As a more specific example, the layers 32 may be arranged in a manner that attenuates incident nuclear radiation, as well as lower energy, secondary ionizing radiation that may result from attenuation of the nuclear radiation. In a specific embodiment, the layers 32 of a radioactivity-limiting element 30 may have at least two different radioactivity-attenuating characteristics. In an even more specific embodiment, the radioactivity-limiting element 30 may include layers 32a and 32b with two different radioactivity-attenuating characteristics, which layers 32a and 32b may be arranged in a repetitive, alternating order. As an example, each layer 32a may comprise a relatively low Z material (e.g., a 0.6 mm thick layer including vinyl and barium sulfate and having a percent solids loading of about 80% to about 82%, by weight, etc.), while each layer 32b may comprise a relatively high Z material (e.g., a 0.6 mm thick layer including vinyl and bismuth oxide and having a percent solids loading of about 85% to about 87%, by weight, etc.). As another option, the layers 32 may be organized so that the atomic number(s) of the element(s) or elemental specie(s) upon which the radioactivity-attenuating material of each layer 32 is based may increase across the thickness of the radioactivity-limiting element 30. Examples of layer 32 organization of this type include arrangements in which layers 32 that have the same properties are grouped together and arrangements in which layers of different characteristics are progressively organized, as well as other types of arrangements. Of course, other ways of organizing layers 32 with different characteristics are also within the scope of this disclosure.

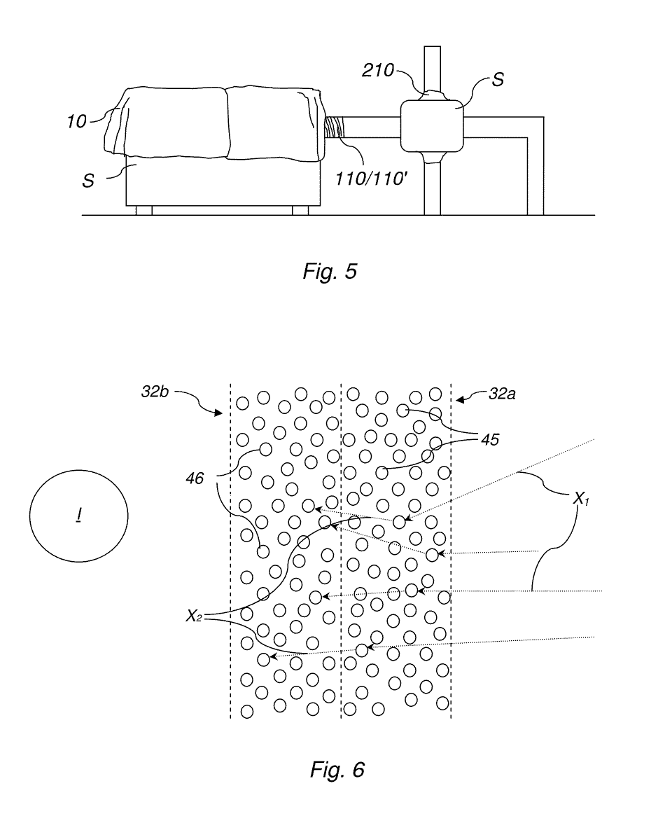

A radiation shield 10 that includes relatively low Z and relatively high Z radioactivity-attenuating materials may used in a manner that optimizes the attenuation of radiation, such as nuclear radiation or other ionizing particles. As an example, when a radiation shield 10 that includes a radioactivity-limiting element 30 having a configuration such as that shown in FIG. 3 and including one or more layers 32a of relatively low Z material and one or more layers 32b of relatively high Z material is used to decrease the amount of radiation present at a particular location, as illustrated by FIG. 5, the radiation shield 10 may be positioned over a source S of radioactivity in an orientation that places at least one layer 32a including the relatively low Z material closer to the source S than at least one layer 32b that includes the relatively high Z material.

As FIG. 6 shows, when incident nuclear radiation X₁, or ionizing particles, pass through the layer 32a that includes the relatively low Z material 45, the relatively low Z material 45 absorbs and, thus, attenuates at least some of the incident nuclear radiation X₁. As the low Z material 45 absorbs the incident nuclear radiation X₁, the atoms, or elemental species, of the relatively low Z material 45 may be excited to a state that causes them to release further, secondary ionizing radiation X₂, or ionizing particles.

The secondary ionizing radiation X₂ may have a lower energy than the incident nuclear radiation X₁. As a consequence, the relatively low Z material 45 of layer 32a may not attenuate the secondary ionizing radiation X₂ as well as it attenuates the incident nuclear radiation X₁, if it attenuates the secondary ionizing radiation X₂ at all. Moreover, the relatively low energy secondary ionizing radiation X₂ is more likely than the incident ionizing radiation X₁ to be absorbed by the tissues of an individuals' body and, thus, be more damaging to the individual. Nevertheless, before that secondary ionizing radiation X₂ can reach the individual, it must pass through at least one layer 32b that includes a relatively high Z material 46, which includes radioactivity-attenuating species that may attenuate the secondary ionizing radiation X₂ better than the relatively low Z material 45 of layer 32a. Thus, the relatively high Z material 46 of layer 32b may reduce the amount of secondary ionizing radiation X₂ that reaches the individual, if not totally prevent exposure of the individual to the secondary ionizing radiation X₂.

A radiation shield 10 that incorporates teachings of this disclosure is configured to limit the transmission of nuclear radiation and/or ionizing particles. Thus, a radiation shield 10 limits the dosages of nuclear radiation and/or ionizing particles to which individuals are subjected when those individuals are present in a setting where sources of nuclear radiation and/or ionizing particles are present. The following EXAMPLES provide a comparison of the ability of a standard lead wool radiation blanket to attenuate nuclear radiation to the ability of a radiation blankets that incorporate teachings from this disclosure to attenuate nuclear radiation.

### EXAMPLE 1

Barium sulfate radiation blankets having weights per unit area of ten (10) pounds per square foot were prepared by stacking twenty-four (24) 0.6 mm thick sheets of sheets of barium sulfate and vinyl having a percent solids loading of about 80% to about 82%, by weight. Although the sheets were superimposed, they were not completely adhered to one another. The superimposed sheets where introduced into the vinyl shell of a conventional lead wool radiation blanket. These barium sulfate radiation blankets were placed, one at a time, separately over a source of mixed radiation, emitting nuclear radiation varying from a rate of about 10 millirad per hour (mrad/hr.) to about 25 mrad/hr., as measured using a radiation survey meter placed on an opposite side of the barium sulfate radiation blanket, The same procedure was repeated with conventional lead wool radiation blankets with weights per unit area of ten (10) pounds per square foot.

On average, when the barium sulfate radiation blankets were used, the radiation survey meter recorded twenty-four percent (24%) less radiation dose exposure than when the lead wool blankets were used. Alternately, for the same dose exposure as lead wool radiation blankets, barium sulfate radiation blankets that are fifteen percent (15%) lighter (in weight per unit area) than those tested (i.e., a barium sulfate radiation blanket having a weight per unit area of 8.5 pounds per square foot) will limit the dosage of radiation to the same extent as the conventional, ten (10) pounds per square foot lead wool radiation blanket.

From the foregoing, it is apparent that barium sulfate attenuates harmful ionizing energy from nuclear radiation more effectively than lead wool. Thus, barium sulfate may be used to provide increased protection from nuclear radiation and ionizing particles, and, thus, greater productivity from workers, who can remain onsite for longer periods of time before being exposed to a threshold dosage of radiation over a predetermined period of time (e.g., 5,000 mrem per year, etc.). Alternatively, barium sulfate may be used to provide lightweight protection equivalent to that provided by conventional radioactivity-attenuating materials (e.g., lead, lead wool, etc.) without compromising safety. Lighter weight reduces the load placed on equipment, which decreases the structural stress on or damage to the equipment on which a radiation shield is placed, as well as the load that may have to be carried by or placed upon an individual. As another option, barium sulfate may be used in radiation shields that provide some combination of more effective protection and lighter weight protection from nuclear radiation and ionizing particles. Barium sulfate lacks the toxicity of conventional radioactivity-attenuating materials. Furthermore, the use of flexible layers, as well as the assembly of a number of flexible layers that can move relative to one another (e.g., slide across each other, etc.) imparts the barium sulfate blankets with significantly more flexibility than conventional radiation blankets (e.g., lead plate radiation blankets, lead wool radiation blankets, tungsten-based radiation blankets, etc.).

### EXAMPLE 2

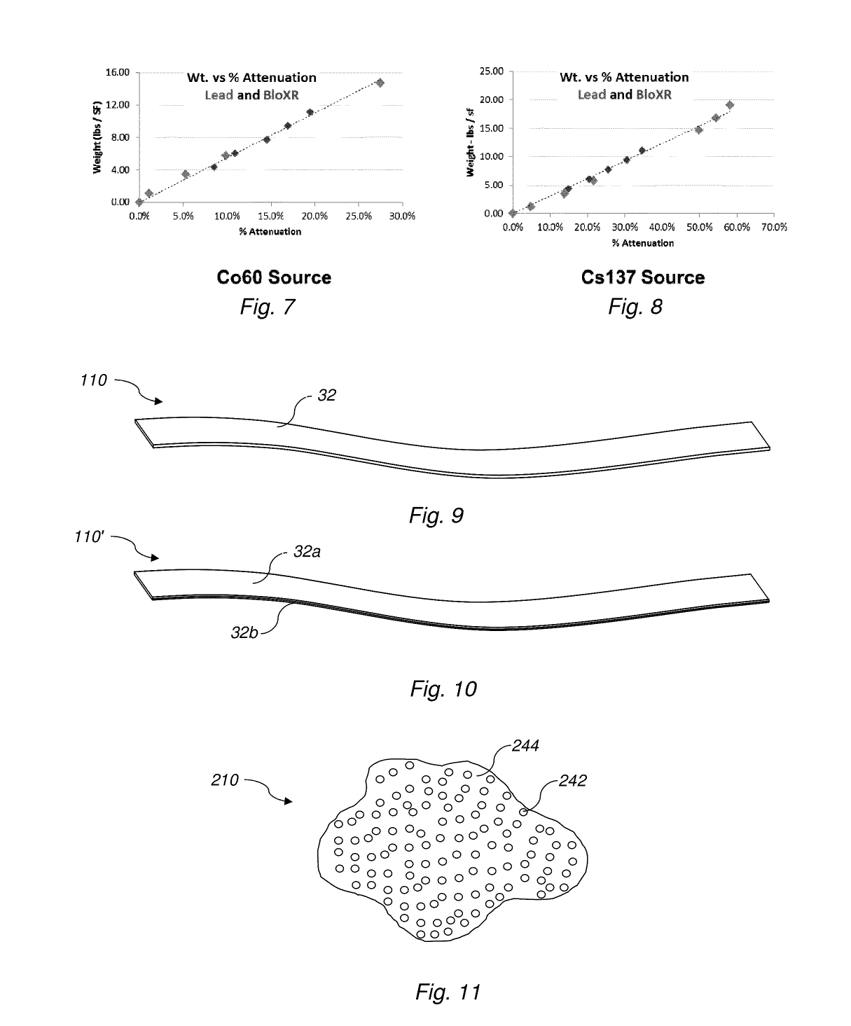

In another study, bismuth oxide and barium sulfate (bilayer) radiation blankets were constructed and tested separately against point sources of cobalt-60, and cesium-137 Similar to the barium sulfate radiation blankets, these bilayer blankets were formed by stacking varying thicknesses of bismuth oxide sheets over nine (9) layers of barium sulfate sheets. An ion chamber was used to measure the dose of radioactivity passing through each bi-layer blanket, and was placed on an opposite side of the bilayer radiation blanket from the point source. The same procedure was repeated with conventional lead wool radiation blankets. Data were collected and analyzed for attenuating performance. It was found that the performance of the bilayer blanket (“BloXR”) was exactly in line with lead-wool blankets (“Lead”) for both the cobalt-60 and the cesium-137 point sources, as shown in the graphs of FIGS. 7 and 8, in which the performance of each bilayer blanket, measured as % Attenuation (x-axis) vs. material weight (lbs/square foot) (y-axis) (see TABLES 1 and 2) matched the performance of the lead wool blankets, as indicated by the fact that the data obtained from the bilayer blankets falls in-line with the performance of the lead-wool blankets.

TABLE 1
Colbalt-60 Source

| | Weight (lbs/ft²) | % Attenuation |
|---|---|---|
| Blanket | (values are approximate) | (values are approximate) |
| Bi₂O₃—BaSO₄ | 4 | 9 |
| Bilayer | 6 | 11 |
| | 8 | 15 |
| | 9 | 17 |
| | 11 | 19 |
| Lead Wool | 1 | 1 |
| | 3 | 5.5 |
| | 6 | 10 |
| | 15 | 28 |

TABLE 2
Cesium-137 Source

| | Weight (lbs/ft²) | % Attenuation |
|---|---|---|
| Blanket | (values are approximate) | (values are approximate) |
| Bi₂O₃—BaSO₄ | 4.5 | 15 |
| Bilayer | 6 | 21 |
| | 8 | 26 |
| | 9 | 31 |
| | 11 | 35 |
| Lead Wool | 1 | 5 |
| | 4 | 14 |
| | 5.5 | 22 |
| | 15 | 50 |
| | 17 | 55 |
| | 19 | 58 |

### EXAMPLE 3

When barium sulfate radiation blankets (see EXAMPLE 1) were evaluated on-site (i.e., at a facility where radioactive materials were present) for attenuation per unit weight, it was found that the performance of the barium sulfate radiation blankets was better than that of lead-wool blankets. The users at the site also noted that the barium sulfate radiation blankets were very pliable and could be easily wrapped around the objects on which radiation blankets are typically used at that site. When tested for attenuating radiation from a filter housing emitting 30 mrad/hr., the % attenuation per unit weight for the tested barium sulfate blanket was 7.0%, whereas the % attenuation for a lead-wool blanket (which was used as a control) was only 6.7%. The radiation level measured 10.5 mrad/hr. downstream of the barium sulfate blankets (i.e., on an opposite side of the blanket from the filter housing), indicating the barium sulfate blanket actually attenuated 65% of the radioactivity emitted from the filter housing.

The data indicate that bismuth oxide and barium sulfate radiation blankets provide comparable or better performance over conventional lead-based radiation blankets. Both materials—barium sulfate, and bismuth oxide lack the toxicity of conventional radiation attenuating materials, such as lead and tungsten. Moreover, the manner in which the barium sulfate and bismuth oxide radiation blankets are constructed imparts them with significantly more flexibility than conventional radiation blankets.

The use of bismuth oxide layers in conjunction with barium sulfate layers in a radiation shield (e.g., a radiation blanket, etc.) may expand the range of energies of nuclear radiation or ionizing particles that may be attenuated by the radiation shield beyond the ranges of energies of nuclear radiation or ionizing particles that may be attenuated by radiation shields that only include one of these materials or the other. Accordingly, the use of both of these materials together, as well as the use of other combinations of radioactivity-attenuating materials with different properties, may provide further attenuation and/or weight advantages over conventionally configured radiation shields.

Turning now to FIGS. 9 and 10, another embodiment of radiation shield for attenuating nuclear radiation or ionizing particles is depicted. In the depicted embodiment, the radiation shield comprises an elongated tape 110. The tape 110 may be flexible, enabling it to be wrapped at least partially around another object. Thus, the tape 110 may include one (FIG. 9) or more (FIG. 10) flexible layers 132, at least one of which may include a radioactivity-attenuating material. In a specific, but non-limiting embodiment, each layer 132 may be configured in the manner shown in FIG. 4 and described in reference to that figure, and, therefore, include a particles 42 of at least one radioactivity-attenuating material that are held together or dispersed throughout a polymer 44.

In a more specific embodiment, a representation of which is provided by FIG. 10, a radioactivity-attenuating tape 110′ may include two layers 132a and 132b. Layer 132a, which defines a bottom surface 114 of the tape 110′, includes a relatively low Z material (e.g., barium sulfate, etc.), while layer 132b, which defines a top surface 112 of the tape 110′, includes a relatively high Z material (e.g., bismuth oxide, etc.). In use, bottom surface 114 of the tape 110′ may be positioned closer to a source S of radioactivity (see, e.g., FIGS. 5 and 6) than the top surface 112 of the tape. Orienting the tape 110′ in this manner may optimize attenuation of radiation in the manner illustrated by and described in reference to FIG. 6.

FIG. 11 depicts an embodiment of a pliable radiation shield 210. A pliable radiation shield 210 may include a pliable substrate 244. The pliable substrate 244 may comprise a material (e.g., a putty, etc.) that may be molded into a desired shape, retain that shape and, optionally, adhered to a substrate. Particles 242 of a radioactivity-attenuating material may be dispersed throughout the pliable substrate 244. In some embodiments, the radioactivity-attenuating material may comprise or be based on a non-toxic element or elemental species having an atomic number of at least 56. Of course, other embodiments of pliable radiation shields are also within the scope of this disclosure, as are embodiments of radiation shields that are based on flowable, or pourable, materials (e.g., gels, paints, resins, etc.), which may be configured to coat at least a portion of a surface of a substrate.

Pliable and/or flowable materials may be used in any suitable manner (e.g., applied to a substrate, etc.). In some embodiments, multiple layers may be used together. In other embodiments, different materials may be used in conjunction with one another. The different layers or different materials may attenuate radioactivity differently from one another, and may be used together in a manner that enables tailoring or optimization of the ability of the combination to attenuate radioactivity, increases the range or ranges of energies of nuclear radiation or ionizing particles that may be attenuated by the combination and/or provides some other desired characteristic.

Returning reference to FIG. 5, a setting is illustrated in which one or more sources S of radioactivity may be present. The setting may comprise a nuclear power plant, a nuclear recycling facility, a nuclear waste facility, a vehicle for transporting nuclear materials or radioactive waste or any other location where an individual may be exposed to nuclear radiation or ionizing particles. When an individual (e.g., a worker, etc.) enters the setting, he or she may identify any sources S or potential sources of radioactivity and use one or more embodiments of radiation shields, including at least one radiation shield that incorporates teachings of this disclosure, to limit his or her exposure to nuclear radiation and/or ionizing particles while he or she, as well as other individuals, are present in the setting. In various embodiments, where the source S of radioactivity is a piece of equipment, one or more radiation blankets (see, e.g., FIG. 1) may be positioned on the equipment in a manner consistent with the teachings of this disclosure. In circumstances where placement of a radiation blanket over the source S may not be appropriate (e.g., a radiation blanket may not cover or surround the source S in a way that limits the emission of nuclear radiation and/or ionizing particles therefrom, the source S may not support the weight of the radiation blanket, etc.), the source S may be covered with one or more other types of radiation shields. As an example, relatively small structures that may be sources S of radioactivity, such as pipes, valves or the like, may be wrapped once or multiple times with a tape (e.g., tape 110, 110′—FIGS. 7 and 8, respectively) or covered with a suitable, specially designed radiation shield. As another example, a pliable radiation shield 210 may be placed over locations that are difficult to cover with radiation blankets or tape (e.g., within the interiors of corners, within recesses of equipment, etc.). With one or more radiation shields in place, the dosage(s) of nuclear radiation and/or ionizing particles may be reduced to levels safe enough to enable individuals to remain in the setting for prolonged periods of time.

Although the foregoing description includes many specifics, these should not be construed as limiting the scope of any of the appended claims, but merely as providing information pertinent to some specific embodiments that may fall within the scopes of the appended claims. Other embodiments may also be devised which lie within the scopes of the appended claims. Features from different embodiments may be employed in combination. The scope of each claim is, therefore, indicated and limited only the language of that claim and its legal equivalents. All additions, deletions and modifications to the disclosed embodiments that fall within the meanings and scopes of the appended claims are to be embraced thereby.

What is claimed:

1. A nuclear radiation shield, comprising:
a shell defining an exterior of the nuclear radiation shield and an interior of the nuclear radiation shield; and
a radioactivity-limiting element within the interior defined by the shell, the radioactivity limiting element including:
of at least one non-toxic, radioactivity-attenuating material based on an element or an elemental species or compound having an atomic number of 56 or greater; and
a polymer holding the particles together, the polymer arranging the particles in a configuration that limits passage of nuclear radiation or ionizing particles through the radioactivity-limiting element.

2. The nuclear radiation shield of claim 1, wherein the radioactivity-limiting element includes a plurality of superimposed layers, each layer of the plurality of superimposed layers including a polymer and particles of the at least one non-toxic, radioactivity-attenuating material carried by the polymer.

3. The nuclear radiation shield of claim 2, wherein the plurality of layers of the radioactivity-limiting element comprises layers that include different non-toxic, radioactivity-attenuating materials.

4. The nuclear radiation shield of claim 3, wherein the different non-toxic, radioactivity-attenuating materials attenuate ionizing nuclear radiation or particles of different energies.

5. The nuclear radiation shield of claim 4, wherein a first non-toxic, radioactivity-attenuating material of a first layer of the plurality of layers comprises barium sulfate and a second non-toxic, radioactivity-attenuating material of a second layer of the plurality of layers comprises bismuth oxide.

6. The nuclear radiation shield of claim 1, wherein the radioactivity-limiting element enables a smaller dose of nuclear radiation or ionizing particles to pass therethrough than a dose of nuclear radiation or ionizing particles that pass through a lead barrier with a same thickness as the radioactivity-limiting element.

7. The nuclear radiation shield of claim 6, wherein the radioactivity-limiting element weighs less than a lead barrier having the same dimensions.

8. The nuclear radiation shield of claim 1, wherein the radioactivity-limiting element resists cracking.

9. The nuclear radiation shield of claim 8, wherein the radioactivity-limiting element is flexible.

10. The nuclear radiation shield of claim 1, wherein the shell and the radioactivity-limiting element form a radioactive protective blanket.

11. A shield for attenuating nuclear radiation or ionizing particles, comprising:
a plurality of layers that are at least partially superimposed relative to one another and that are enabled to move longitudinally relative to one another; and
a radioactivity-attenuating material in at least one layer of the plurality of layers.

12. The shield of claim 11, wherein the ability of the plurality of layers to move longitudinally relative to one another imparts the shield with flexibility.

13. The shield of claim 12, wherein each layer of the plurality of layers is flexible.

14. The shield of claim 13, wherein the radioactivity-attenuating material comprises a non-toxic, radioactivity-attenuating material based on an element or an elemental species having an atomic number of 56 or greater.

15. The shield of claim 14, wherein particles of the radioactivity-attenuating material are carried by a polymer of the at least one layer.

16. The shield of claim 15, wherein the particles of the radioactivity-attenuating material are held together or dispersed in the polymer.

17. The shield of claim 11, wherein the plurality of layers comprises at least twenty layers.

18. The shield of claim 17, wherein the plurality of layers comprises up to thirty layers.

19. The shield of claim 11, further comprising:
a shell for carrying the plurality of layers.

20. The shield of claim 11, wherein the plurality of layers comprises a plurality of layers of pliable material or flowable material.

21. A shield for attenuating nuclear radiation or ionizing particles, comprising:
a first radioactivity-attenuating material for attenuating nuclear radiation or ionizing particles having a first range of energies; and
a second radioactivity-attenuating material for attenuating nuclear radiation or ionizing particles having a second range of energies, the second range of energies differing at least partially from the first range of energies.

22. The shield of claim 21, wherein the first radioactivity-attenuating material comprises or is based on an element or an elemental species with a first atomic number and the second radioactivity-attenuating material comprises or is based on an element or an elemental species with a second atomic number, the first atomic number being smaller than the second atomic number.

23. The shield of claim 22, wherein the first radioactivity-attenuating material is located to be positioned closer to a source of nuclear radiation or ionizing particles than the second radioactivity-attenuating material.

24. The shield of claim 23, further comprising:
a shell with an interior for carrying the first radioactivity-attenuating material and the second radioactivity-attenuating material.

25. The shield of claim 24, wherein shell includes a top surface and a bottom surface that are visibly distinguishable from one another.

26. The shield of claim 25, wherein the first radioactivity-attenuating material is positioned closer to the bottom surface of the shell than the second radioactivity-attenuating material and the second radioactivity-attenuating material is positioned closer to the top surface of the shell than the first radioactivity-attenuating material.

27. The shield of claim 21, wherein the first and second radioactivity-attenuating materials comprise superimposed elongated flexible strips that form a tape.

28. A material for attenuating nuclear radiation or ionizing particles, comprising:
a pliable component configured to be molded into a shape and retain the shape; and
at least one radioactivity-attenuating material dispersed throughout the pliable component.

29. The material of claim 28, wherein the pliable component is configure to adhere to a substrate.

30. The material of claim 28, wherein the pliable component comprises a putty.

31. The material of claim 28, wherein the at least one radioactivity-attenuating material comprises a non-toxic, radioactivity-attenuating material based on an element or an elemental species having an atomic number of 56 or more.

32. A material for attenuating nuclear radiation or ionizing particles, comprising:
a flowable component configured to be applied to coat a substrate; and
at least one radioactivity-attenuating material dispersed throughout the flowable component.

33. A method for limiting a dosage of nuclear radiation or ionizing particles to which an individual is exposed, comprising:
positioning a low Z radioactivity-attenuating material between a source of radioactivity and the individual to absorb incident nuclear radiation or ionizing particles from the source; and
positioning a high Z radioactivity-attenuating material between the low Z radioactivity-attenuating material and the individual to absorb secondary ionizing radiation from the low Z radioactivity-attenuating material.

34. The method of claim 33, wherein positioning the low Z radioactivity-attenuating material and positioning the high Z radioactivity-attenuating material comprises:
placing a radiation shield including the low Z radioactivity-attenuating material and the high Z radioactivity-attenuating material between the source and the individual; and
orienting the radiation shield with the low Z radioactivity-attenuating material being located closer to the source than the high Z radioactivity-attenuating material.

35. The method of claim 33, wherein positioning at least one of the low Z radioactivity-attenuating material and the high Z radioactivity-attenuating material comprises securing a pliable or flowable material to a substrate.
